(19) United States
(12) Patent Application Publication
(10) Pub. No.: US 2015/0146453 A1
(43) Pub. Date: May 28, 2015

(54) PLANAR LIGHT SOURCE DEVICE AND DISPLAY DEVICE HAVING THE SAME

(71) Applicant: Mitsubishi Electric Corporation, Tokyo (JP)

(72) Inventor: Seiji SAKAI, Tokyo (JP)

(73) Assignee: MITSUBISHI ELECTRIC CORPORATION, Tokyo (JP)

(21) Appl. No.: 14/535,715

(22) Filed: Nov. 7, 2014

(30) Foreign Application Priority Data
Nov. 26, 2013 (JP) 2013-243952

(51) Int. Cl. F21V 8/00

(52) U.S. Cl. CPC G02B 6/0055; G02B 6/0083; G02B 6/0073; F21Y 2105/00
USPC 362/612; 362/611

(57) ABSTRACT

A planar light source device includes a housing having an opening, point light sources arranged on at least one side surface in the housing, a light guide plate arranged in the housing and having a light-emitting surface facing the opening and a counter-emitting surface being opposite to the light-emitting surface, a reflecting sheet arranged on the counter-emitting surface side of the light guide plate in the housing, and a reflecting region arranged on at least a part of a peripheral portion of the point light sources on the side surface on which the point light sources are arranged in the housing and absorbing light having at least some wavelength.

### BACKGROUND OF THE INVENTION

1. Field of the Invention

The present invention relates to a planar light source device that performs irradiation by using point light sources and a display device including the same.

2. Description of the Background Art

A liquid crystal display device serving as a display device includes a liquid crystal panel on which a plurality of pixels that control light transmission amounts and a planar light source device that irradiates the liquid crystal panel with light.

As a light source of a planar light source device, a light-emitting diode (LED: Light Emit Diode) is used because of a reduction in power consumption or the like. In particular, a pseudo white LED obtained by combining a semiconductor chip emitting blue light and a phosphor excited by the blue light to emit yellow light to each other is prevailed.

However, in a pseudo white LED, a degree of whiteness largely fluctuates depending on a wavelength of light emitted from a semiconductor chip and a density and an amount of phosphor. In this manner, the degree of whiteness of the liquid crystal panel also largely fluctuates.

In order to solve the problem, for example, Japanese Patent Application Laid-Open No. 2004-31023 and Japanese Patent Application Laid-Open No. 2008-83597 disclose a technique in which a colored sheet or a fluorescent layer is arranged between a light source and a light-emitting surface to absorb excessive light or convert the wavelength of the excessive light so as to make it possible to adjust the chromaticity of the planar light source device.

However, in the planar light source device described in Japanese Patent Application Laid-Open No. 2004-31023 or Japanese Patent Application Laid-Open No. 2008-83597, since a colored sheet or a fluorescent layer is arranged on an optical path of light that is planarly emitted, the transmission characteristics of the colored sheet or the fluorescent layer considerably influence the chromaticity of the planar light source device. A loss of light occurs when light transmits the colored sheet or the fluorescent layer to decrease the brightness of the planar light source device. For this reason, the planar light source device and the display device cannot achieve sufficient display quality.

### SUMMARY OF THE INVENTION

An object of the present invention is to provide a planar light source device that can achieve sufficient display quality and a display device including the planar light source device.

A planar light source device according to the present invention includes a housing having an opening, a light source arranged on at least one side surface in the housing, and a light guide plate arranged in the housing and having a light-emitting surface facing the opening, and a counter-emitting surface being opposite to the light-emitting surface. The planar light source device further includes a first reflecting sheet arranged on the counter-emitting surface side of the light guide plate in the housing, and a reflecting region arranged on a part of a peripheral portion of the light source on the side surface on which the light source is arranged in the housing, and absorbing light having at least some wavelength.

The display device according to the present invention includes a planar light source device, and a display unit arranged on the light-emitting surface side in the planar light source device.

A planar light source device includes a housing having an opening, a light source arranged on at least one side surface in the housing, a light guide plate arranged in the housing and having the light-emitting surface facing the opening and a counter-emitting surface being opposite to the light-emitting surface. The planar light source device further includes a first reflecting sheet arranged on the counter-emitting surface side of the light guide plate in the housing, and a reflecting region arranged on a part of a peripheral portion of the light source on the side surface on which the light source is arranged in the housing and absorbing light having at least some wavelength.

Thus, of light emitted from the light source, a part of light that is not incident on the light guide plate can be reflected by the reflecting region and incident on the light guide plate, so that a brightness on the light-emitting surface can be improved. Of light emitted from the light source and being incident on the light guide plate, light having some wavelength is absorbed by the reflecting region. However, only the color of light reflected by the reflecting region changes, and the color of light emitted from the light-emitting surface does not largely change, so that fine color adjustment can be achieved. In this manner, sufficient display quality can be achieved.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is an exploded perspective view of a planar light source device according to a first preferred embodiment;

FIG. 2 is a plan view of the planar light source device;

FIG. 3 is a sectional view along an A-A line in FIG. 2;

FIG. 4 is a sectional view of a pseudo white light emitting diode;

FIG. 5 is a diagram of an emission spectrum of the pseudo white light emitting diode;

FIG. 6 is a front view of a reflecting sheet arranged on a point light source 7 side;

FIG. 7 is a graph showing a relationship between a wavelength and a reflectance in a reflecting region on the reflecting sheet;

FIG. 8 is a graph showing the chromaticity of the planar light source device;

FIG. 9 is a perspective view of a planar light source device according to a modification of the first preferred embodiment;

FIG. 10 is a diagram corresponding to FIG. 3 of the modification of the first preferred embodiment;

FIG. 11 is a diagram corresponding to FIG. 3 of a second preferred embodiment;

FIG. 12 is a diagram corresponding to FIG. 3 of a first modification of the second preferred embodiment; and

FIG. 13 is a diagram corresponding to FIG. 3 of a second modification of the second preferred embodiment.

### DESCRIPTION OF THE PREFERRED EMBODIMENTS

### First Preferred Embodiment

A first preferred embodiment of the present invention will be described below with reference to the accompanying drawings.

(Configuration of Planar Light Source Device)

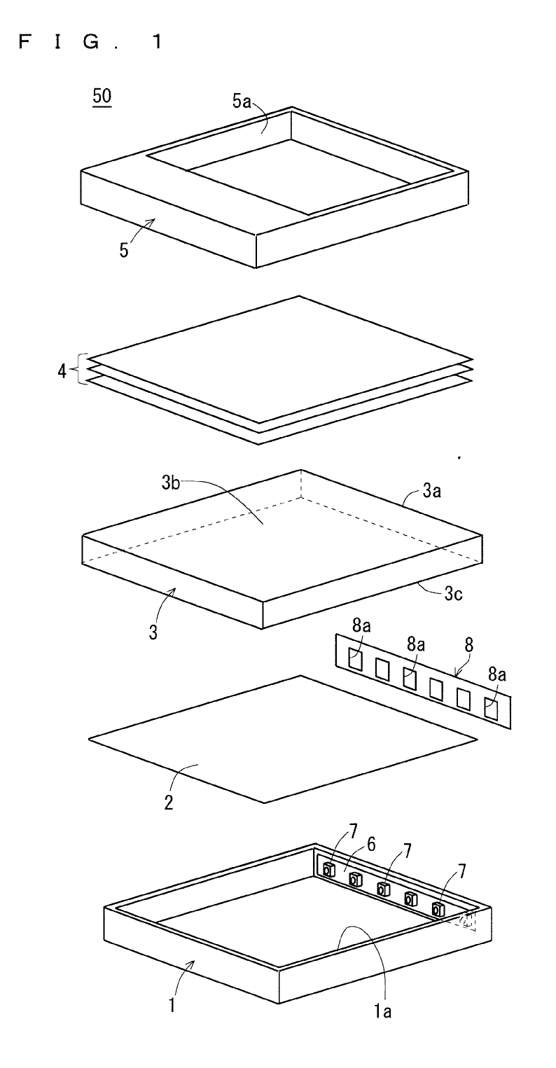

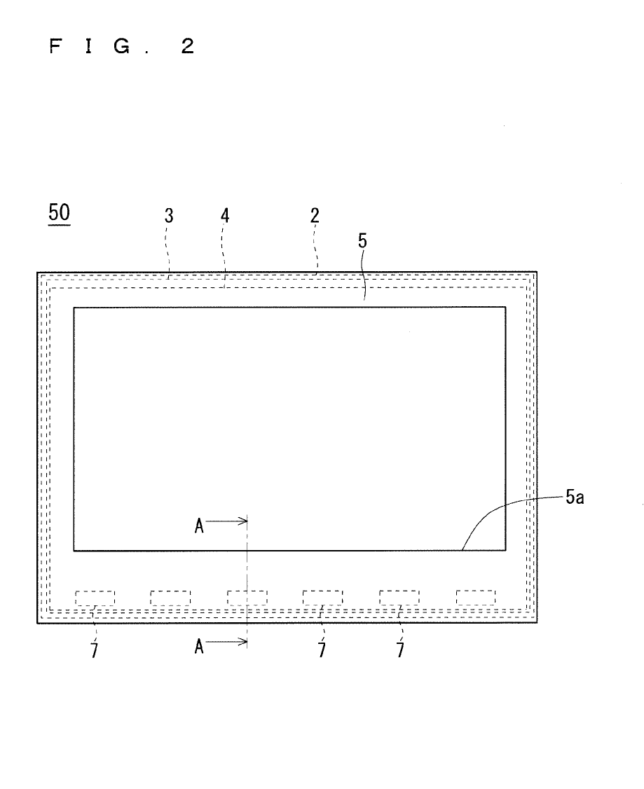

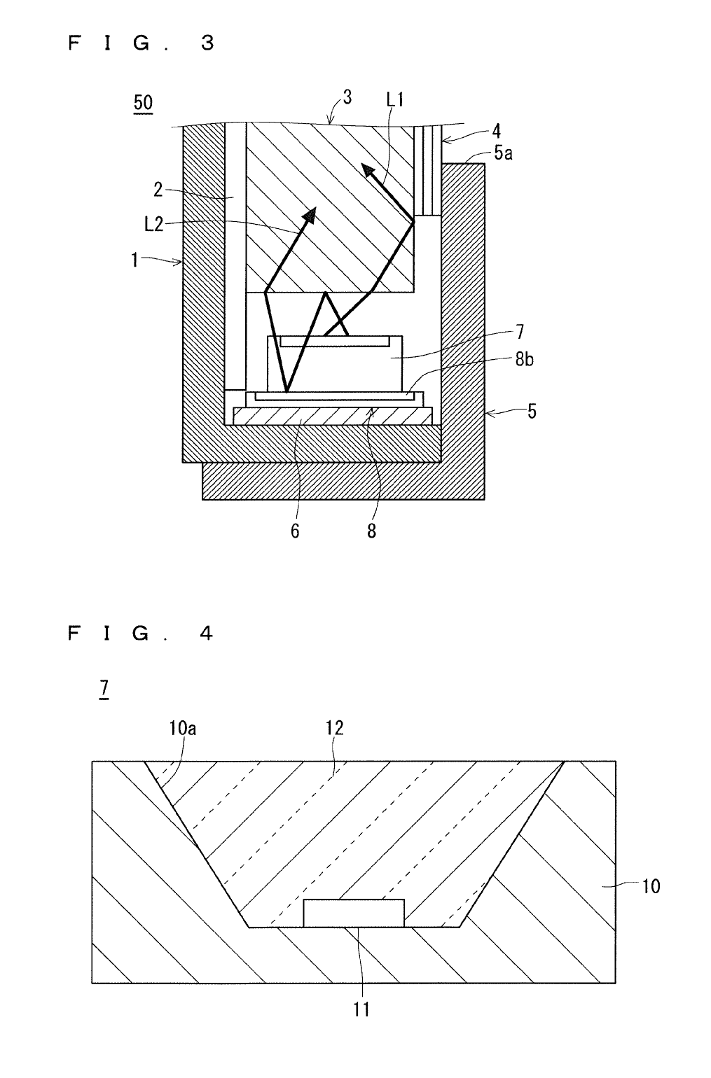

FIG. 1 is an exploded perspective view of a planar light source device 50 according to a first preferred embodiment, FIG. 2 is a plan view of the planar light source device 50, and FIG. 3 is a sectional view along an A-A line in FIG. 2. The planar light source device 50 is a device that partially configures a liquid crystal display device (display device) (will be described later).

As shown in FIG. 1 and FIG. 2, the planar light source device 50 includes a lower case 1 configuring a lower part of a housing, a reflecting sheet 2 (first reflecting sheet), a light guide plate 3, optical sheets 4, an upper case 5 configuring an upper part of the housing, a plurality of point light sources 7 (light source), and a reflecting sheet 8 (second reflecting sheet).

The lower case 1 includes an internal space 1a that can store the components therein. In the internal space 1a (i.e., the interior of the housing) of the lower case 1, the point light sources 7, a flat cable 6, the light guide plate 3, the optical sheets 4, and reflecting sheets 2 and 8 are stored. The plurality of point light sources 7 are mounted on the flat cable 6 while being arranged in a line.

The point light sources 7 is arranged at a position facing a side surface (side surface on which light from the point light sources 7 is incident will be called an incident surface 3a) on one side of the light guide plate 3 in the internal space 1a of the lower case 1. More specifically, the point light sources 7 are arranged on the side surface (side surface of the space in the housing) of the internal space 1a regulated by the housing, light from the point light sources 7 being incident from the incident surface 3a is emitted from a light-emitting surface 3b of the light guide plate 3. The optical sheets 4 are arranged on the light-emitting surface 3b side of the light guide plate 3, and the reflecting sheet 2 is arranged on a counter-emitting surface 3c side of the light guide plate 3. In this case, the counter-emitting surface 3c is a surface being opposite to the light-emitting surface 3b on the light guide plate 3. The planar light source device 50 is configured such that the upper case 5 and the lower case 1 hold the point light sources 7, the flat cable 6, the light guide plate 3, the optical sheets 4, and the reflecting sheets 2 and 8 therebetween.

An opening 5a is formed in the upper case 5, and the light-emitting surface 3b of the light guide plate 3 is arranged to face the opening 5a. For this reason, the planar light source device 50 can emit planar light from the opening 5a. As shown in FIG. 2, the opening 5a is formed to be positioned inside the peripheral portion of the light guide plate 3. A side surface on which the point light sources 7, the flat cable 6, and the reflecting sheet 8 are arranged in the lower case 1 in FIG. 1 is different from a side surface in the lower case 1 in FIG. 2. The components will be described below in detail.

(Configuration of Point Light Source)

The point light sources 7 are formed by using light-emitting diodes (LED: Light Emit Diode). The point light sources 7 may be formed by using not only the LEDs but also laser diodes (Laser Diodes) or the like. In particular, as the LED, a semiconductor light-emitting element emitting light of a single color such as blue or a pseudo white LED or the like including a phosphor that partially absorbs blue light emitted from a semiconductor light-emitting element to emit yellow light may be used. As the LED, an LED that includes RED (red), GREEN (green), and BLUE (blue) elements and synthesizes three single light rays with each other to emit white light may be used. In the embodiment, the pseudo white LED is used as the point light source 7.

FIG. 4 is a sectional view of the pseudo white light-emitting LED. FIG. 4 shows a pseudo white element including a fluorescent layer 12 in which a yellow fluorescent material is dispersed. The pseudo white LED serving as the point light source 7 includes a mold 10 configured by a resin or ceramic molded product, a blue semiconductor 11, and the fluorescent layer 12. The mold 10 is formed in a box-like shape having an opening 10a. On the bottom surface of the opening 10a, the blue semiconductor 11 that emits blue light is arranged.

The blue semiconductor 11 is electrically connected to an electrode arranged on the bottom surface of the lower case 1. In the internal space of the opening 10a of the mold 10, the fluorescent layer 12 is buried to cover the blue semiconductor 11. In this case, the fluorescent layer 12 is formed by using a material obtained by mixing a finely granular yellow phosphor with a resin such as transparent silicon.

For this reason, when the pseudo white LED is energized, a part of light emitted from the blue semiconductor 11 hits on the finely granulated phosphor in the transparent resin such as silicon to excite the phosphor so as to emit yellow light. The yellow light is radiated from the opening 10a of the mold 10 to the outside. A part of light emitted from the blue semiconductor 11 is radiated from the opening 10a of the mold 10 without hitting on the fine grains in the transparent resin such as silicon to emit blue light. Mixed light of the yellow light and the blue light is visually recognized as white light for a human eye.

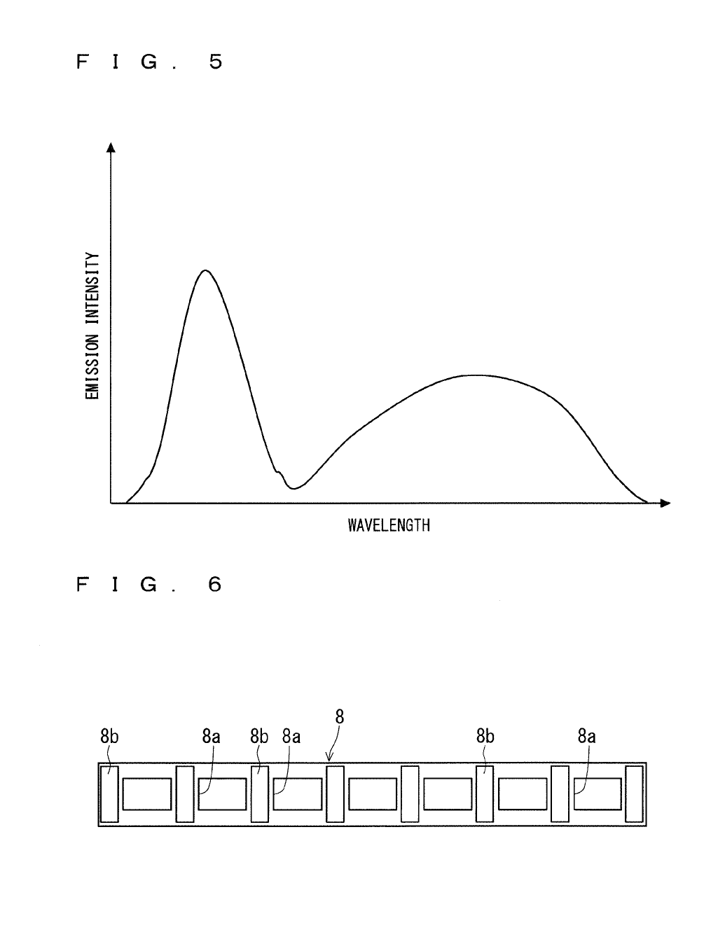

FIG. 5 is a diagram of an emission spectrum of a pseudo white LED. As shown in FIG. 5, in the pseudo white LED, a chromaticity changes depending on the balance between a blue spectrum and a yellow spectrum that change a ratio of a yellow phosphor mixed with a white resin such as silicon. Even though the phosphor ratio does not change, the balance between the blue spectrum and the yellow spectrum changes depending on an amount of a mixture between the white resin such as silicon and the phosphor, and color emitted from the pseudo white LED changes.

Even though a dominant wavelength and a half bandwidth of a spectrum of light emitted from the blue semiconductor 11 or a dominant wavelength and a half bandwidth of a spectrum of light emitted from the phosphor changes, the chromaticity changes. Since components (spectrums) of light radiated from the pseudo white LED are determined by a plurality of factors, the chromaticity fluctuates.

(Configuration of Flat Cable)

The flat cable 6 is a flexible circuit board (FPC: Flexible Printed Circuits), a flexible flat cable (FTC: Flexible Flat Cable), or the like. In general, a flat cable has a structure obtained by forming an adhesive layer on a film-like insulator (base film) having a thickness of 12 μm to 50 μm and then forming a conductor foil having a thickness of about 12 μm to 50 μm on the adhesive layer. For this reason, the flat cable 6 can be reduced in thickness. In addition, the flat cable 6 can be repeatedly transformed with small force. Even though the flat cable 6 is transformed, electric characteristics thereof can be maintained.

As shown in FIG. 1, the point light sources 7 are mounted on the flat cable 6 serving as a circuit board at predetermined intervals. The flat cable 6 on which the point light sources 7 are mounted is arranged to be opposite to the incident surface 3a of the light guide plate 3. The point light sources 7 and the flat cable 6 are arranged on one side surface of the light guide plate 3 in FIG. 1. However, this arrangement is not limited thereto, and the point light sources 7 and the flat cable 6 may be arranged on two or more side surfaces of the light guide plate 3.

The flat cable 6 not only hold the point light sources 7 but also have a circuit pattern for supplying an electric power to the point light sources 7. The point light sources 7 are mounted on the thin flat cable 6 to make it possible to more efficiently transmit heat from the point light sources 7 to the periphery. Furthermore, since the flat cable 6 has a thin base plate, the flat cable 6 is used as a circuit board to make it possible to advantageously reduce the external size of the planar light source device 50.

(Configuration of Light Guide Plate)

The light guide plate 3 will be described below. The light guide plate 3 is formed by using a transparent acrylate resin, a polycarbonate resin, glass, or the like. On the counter-emitting surface 3c of the light guide plate 3, a scattering unit (not shown) to disturb a propagation direction of light to guide the light to the light-emitting surface 3b is formed. The scattering unit functions as means that reflects light toward the interior of the light guide plate 3. More specifically, a method of printing a dot pattern on the counter-emitting surface 3c, a method of coarsening the counter-emitting surface 3c, a method of forming an unevenness such as a fine spherical surface or a prism that changes a propagation direction of light on the counter-emitting surface 3c, and the like are used.

(Configuration of Optical Sheets)

On the light-emitting surface 3b side of the light guide plate 3, the optical sheets 4 including a plurality of optical sheets are arranged. More specifically, the optical sheets 4 has a configuration obtained by sandwiching a lens sheet between diffusion sheets. When the brightness of the planar light source device 50 is to be improved, in consideration of the direction of a prism formed on the surface of the lens sheet, a plurality of lens sheets may be combined to each other. Two or more lens sheets may be used in combination with each other to improve diffusion properties. Depending on the light distribution characteristics of the lens sheet, one lens sheet may be used for the optical sheets 4. When the diffusion properties do not need to be improved, the lens sheet may not be used.

As the optical sheets 4, a protecting sheet, a lens sheet, or a reflection polarizing sheet may be combined to each other. The use of the optical sheets 4 is preferably optimized in consideration of a brightness to be required, light distribution characteristics to be required, and the like.

(Configuration of Upper Case)

The upper case 5 has the opening 5a through which light from the light-emitting surface 3b of the light guide plate 3 is transmitted, and the other portions are sealed with the upper case 5 and the lower case 1 so as not to cause light to leak to the outside as much as possible. The upper case 5 can be formed by using a metal material such as aluminum, stainless steel, or iron or a resin material such as polycarbonate (PC: Polycarbonate) or acrylonitrile butadiene styrene (ABS: Acrylonitrile butadiene styrene).

(Configuration of Upper Case)

The lower case 1 has a function of transmitting heat radiated from the point light sources 7 to radiate the heat to the periphery. The lower case 1 requires high strength because the lower case 1 must store the members therein and position the members at predetermined positions, respectively. For this reason, the lower case 1 is desirably formed by using a metal having high strength and high heat conductivity. In particular, an aluminum or aluminum-alloy case having high heat conductivity is used as the lower case 1 to make it possible to efficiently diffuse heat from the point light sources 7 and to decrease the temperature of the point light sources 7. In order to efficiently release heat spreading in the lower case 1, the lower case 1 is especially desirably arranged on an outermost periphery of the planar light source device 50.

(Configuration of Liquid-crystal Display Device)

A liquid crystal display device (display device) including the planar light source device 50 will be described below. The liquid crystal display device includes the planar light source device 50 and a display unit (not shown). In the following explanation of the display unit, members configuring the display unit are not shown in the drawings. In the planar light source device 50, the display unit formed by using a liquid crystal or the like can be arranged on the opening 5a of the upper case 5. More specifically, the display unit is arranged on the light-emitting surface 3b of the light guide plate 3 through the optical sheets 4. When the display unit arranged on the upper side of the planar light source device 50 uses a liquid crystal, the display unit is a display unit to which the birefringence of the liquid crystal is applied. When the display unit uses a liquid crystal (to be also referred to as a liquid crystal display unit hereinafter), the display unit includes a counter substrate obtained by forming a colored layer, a light shielding layer, counter electrodes, and the like on an insulating substrate made of glass or the like and a TFT array substrate obtained by forming a thin film transistor (TFT) serving as a switching element, pixel electrodes, and the like on an insulating substrate made of glass or the like.

The liquid crystal display unit further includes a spacer for holding an interval between the counter substrate and the TFT array substrate, a seal material for bonding the counter substrate and the TFT array substrate to each other, a liquid crystal held between the counter substrate and the TFT array substrate, a sealing material for an injection port for injecting the liquid crystal, a light-distribution film for causing the liquid crystal to perform light distribution, a polarizing plate, and the like. In the embodiment, since a normal liquid crystal display unit is used as the liquid crystal display unit, a detailed description thereof will not be performed.

The liquid crystal display device further includes a circuit board for driving the display unit. The circuit board is formed by using glass epoxy or the like. A copper pattern is formed on the circuit board, and a plurality of electronic components are mounted by soldering. The circuit board is mainly arranged on a rear-surface side (side from which light is not emitted, i.e., on the counter-emitting surface 3c side) of the planar light source device 50 and physically connected to the planar light source device 50 by a fastening screw, caulking, a catching claw, or the like.

A protecting cover is attached to protect the circuit board from an external pressure and external static electricity. As the material of the protecting cover, aluminum, stainless steel, or galvanized sheet iron, or the like is used. A resin sheet made of polyethylene terephthalate (PET: Polyethylene Terephthalate) or the like is stuck to the protecting cover on the circuit board side to avoid the protecting cover from being brought into electric contact with the circuit board and the electronic components on the circuit board. The protecting cover is physically connected to the rear surface of the planar light source device 50 by a screw, caulking, or the like.

In the protecting cover, in order to make it possible to control a variable resistor on the circuit board after the protecting cover is attached, a through hole is formed near the variable resistor. When an external pressure is low, a PET sheet can be used in place of the protecting cover. In this case, since it is not necessary to stick an insulating sheet between the PET sheet and the circuit board, the number of components can be reduced to make it possible to suppress the manufacturing cost.

(Configuration of First Reflecting Sheet)

The members configuring the planar light source device 50 is described again, and the reflecting sheet 2 will be described below. As shown in FIG. 1, the reflecting sheet 2 is arranged on the side opposed to the light-emitting surface 3b side of the light guide plate 3. As the material of the reflecting sheet 2, a material obtained by mixing barium sulfate or titanium oxide with polypropylene (PP: Polypropylene) or PET is used. As the reflecting sheet 2, a material obtained by forming fine bubbles in a resin, a material obtained by depositing silver on a metal plate, a material obtained by applying a paint containing titanium oxide or the like to a metal plate, or the like may be used.

The reflecting sheet 2 desirably has a reflectance of 90% or more. For this purpose, a plurality of reflecting sheets 2 are superposed on each other to make it possible to increase the reflectance. When the reflectance of the reflecting sheet 2 is increased, a brightness at the opening 5a increases. When dot printing is performed to the surface of the reflecting sheet 2 on the light guide plate 3 side or on the surface on a side opposed to the light guide plate 3 side, brightness uniformity on the light-emitting surface 3b of the light guide plate 3 can be improved.

Furthermore, when color printing is performed to the reflecting sheet 2, a color change on the light-emitting surface 3b caused by light absorption on the light guide plate 3 or light absorption on the reflecting sheet 2 can be canceled. When printing is performed on the surface on the side opposed to the light guide plate 3 side of the reflecting sheet 2, an influence on the light-emitting surface 3b can be finely adjusted, and uneven brightness and uneven color between the point light sources 7 can be controlled and easily suppressed advantageously.

(Configuration of Second Reflecting Sheet)

As shown in FIG. 1, in the lower case 1, the reflecting sheet 8 (second reflecting sheet) is arranged in a region except for the region in which the point light sources 7 are arranged on the side surface on which the point light sources 7 are arranged. More specifically, the reflecting sheet 8 is arranged on the surface of the flat cable 6 on which the point light sources 7 are mounted. A plurality of holes 8a each having a size slightly larger than the outer size of the point light source 7 are formed in the reflecting sheet 8. The reflecting sheet 8 and the flat cable 6 are fixed with an adhesive material, a double-sided tape, or the like while the point light sources 7 are exposed from the holes 8a.

In this manner, a part of light that is not incident on the light guide plate 3 can be reflected by the reflecting sheet 8 and incident on the light guide plate 3, and the brightness on the light-emitting surface 3b can be improved. Although not shown in

FIG. 1, in the lower case 1, the reflecting sheet 8 is arranged on a side surface being opposite to a side surface except for the incident surface 3a of the light guide plate 3 to increase an amount of light being incident on the light guide plate 3 through the reflecting sheet 8. For this reason, the brightness on the light-emitting surface 3b can be more improved.

The reflecting sheet 8 is formed by using a material obtained by mixing barium sulfate or titanium oxide with PP or PET. The reflecting sheet 8 may be formed by using a material obtained by forming fine bubbles in a resin, a material obtained by depositing silver on a metal plate, a material obtained by applying a paint containing titanium oxide or the like to a metal plate, or the like. The reflecting sheet 8 desirably has a reflectance of 90% or more.

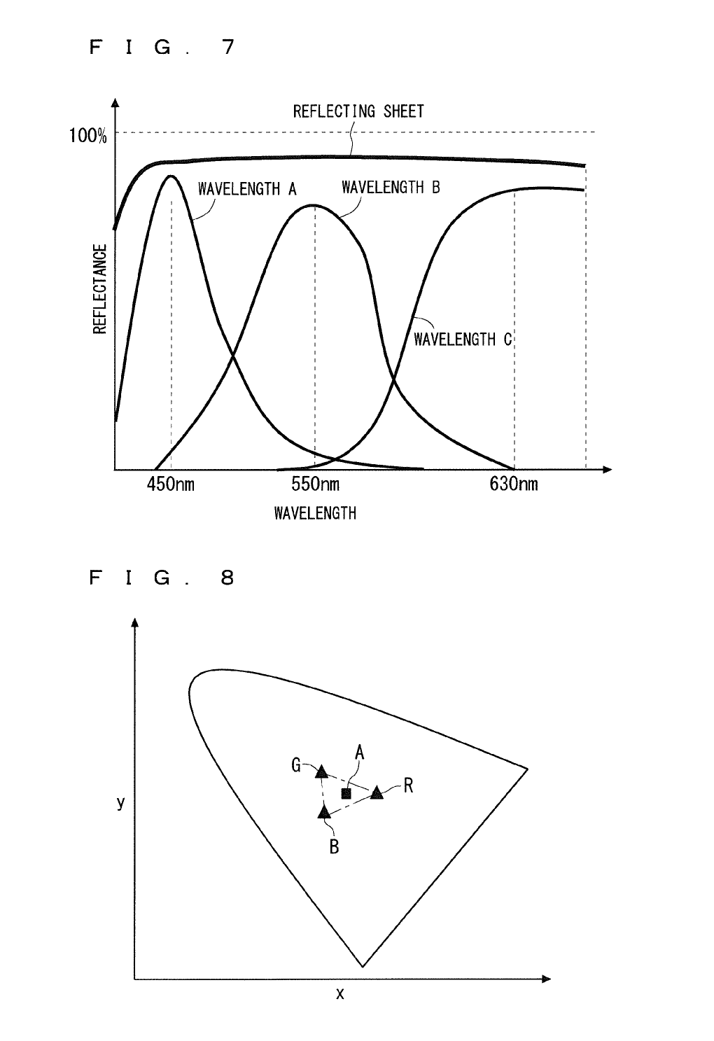

FIG. 6 is a front view of the reflecting sheet 8 arranged on the point light source 7 side. As shown in FIG. 6, a reflecting region 8b that absorbs light having at least some wavelength is formed on a part of the reflecting sheet 8. The reflecting region 8b is formed by performing color printing to the reflecting sheet 8 to change the reflectance of a visible light ray depending on wavelengths.

FIG. 7 is a graph showing a relationship between a wavelength and a reflectance in the reflecting region 8b on the reflecting sheet 8. As shown in FIG. 7, it is understood that the reflecting region 8b having a wavelength A has a sharp reflection peak at a wavelength of about 450 nm (450±20 nm), the reflecting region 8b having a wavelength B has a sharp reflection peak at a wavelength of about 550 nm (550±20 nm), and the reflecting region 8b having a wavelength C has a sharp reflection peak at a wavelength of about 630 nm (630±20 nm).

In the first preferred embodiment, for example, the reflecting region having the wavelength A is the reflecting region 8b colored in blue, the reflecting region having the wavelength B is the reflecting region 8b colored in green, and the reflecting region having the wavelength C is the reflecting region 8b colored in red. The reflecting regions 8b in the colors are formed by performing dot printing to an entire surface or a part of the reflecting regions 8b by, for example, a screen printing method. The shape, sizes, arrangement, thickness, and density of dots, the color of an ink, and changes thereof are desirably optimized in consideration of the chromaticity of the opening 5a and display quality of a film color distribution. A method of forming the reflecting region 8b on the reflecting sheet 8 is not limited to the screen printing method as long as the reflecting region 8b having the same effect as described above can be formed by a method such as deposition or spray coating.

As the method of forming the reflecting region 8b, a method of applying a phosphor can also be employed. The phosphor absorbs energy of light, especially, blue light emitted from the point light sources 7 to excite electrons. When the electrons return to a ground state, excessive energy is radiated as electromagnetic waves. In this manner, an emission spectrum different from the spectrum of light being incident on the phosphor can be generated. For this reason, in comparison with a spectrum absorption type such as printing, the phosphor can achieve spectrum conversion (color conversion) without largely decreasing a loss of light.

The reflecting region 8b may be formed on a part except for the reflecting sheet 8, and the reflecting sheet 8 does not need to be always used as long as a film sheet such as paper sheet or a PET sheet that can be colored is used. Since the reflecting region 8b is formed on a portion that is not in directly tight contact with other members, the coating or the phosphor in the reflecting region can be avoided from being melted and adhering to the other members, thereby eliminating the possibility of deteriorating display performance.

(Path of Light)

A path of light will be described below. As indicated by L1 in FIG. 3, most of light rays emitted from the point light sources 7 are incident on the side surface (incident surface 3a) of the light guide plate 3. The light being incident on the light guide plate 3 propagates in the light guide plate 3 while being repeatedly reflected between the light-emitting surface 3b and the counter-emitting surface 3c of the light guide plate 3. Light being incident on the dots formed on the counter-emitting surface 3c of the light guide plate 3 emit from the light-emitting surface 3b side of the light guide plate 3. Light distribution for the light emitted from the light-emitting surface 3b side is controlled by the optical sheets 4 to polarize the light, and the light is emitted from the opening 5a of the upper case 5.

As indicated by L2 in FIG. 3, of a part of light emitted from the point light sources 7, a part of light being incident on the incident surface 3a of the light guide plate 3 at a large incident angle is reflected by the incident surface 3a to the point light sources 7 side. The reflected light is reflected by the reflecting region 8b of the reflecting sheet 8 arranged between the adjacent point light sources 7. In this case, a spectrum of light emitted from the point light sources 7 is reflected by the reflecting region 8b to largely change the spectrum of light.

For example, on the reflecting region 8b colored in blue indicated by the wavelength A in FIG. 7, light having a wavelength of about 450 nm in the spectrum from the point light sources 7 is mainly reflected. The other light is absorbed by the reflecting region 8b. The reflected light is incident on the incident surface 3a of the light guide plate 3 again. The light being incident on the light guide plate 3 again is mixed in color with light being directly incident on the point light sources 7 to emit the mixed light is emitted from the opening 5a of the upper case 5.

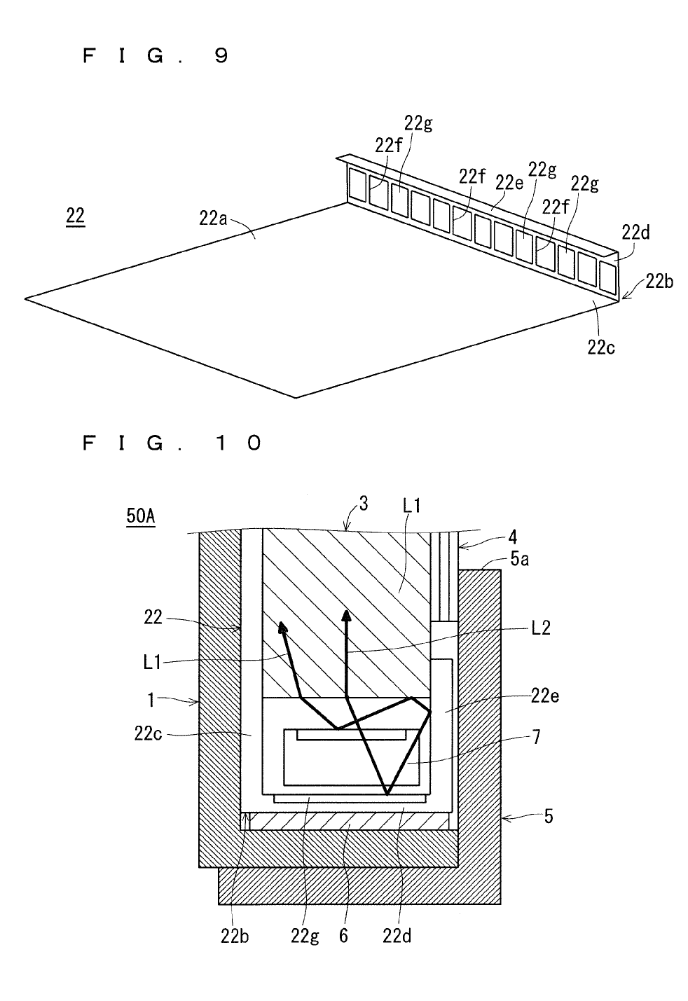

FIG. 8 is a graph showing the chromaticity of the planar light source device 50. Reference symbol A indicates the chromaticity of a normal planar light source device. Reference symbols R, G, and B indicate chromaticities obtained when the reflecting sheet 8 is arranged, respectively. The normal planar light source device is a planar light source device in which the reflecting sheet 8 is not arranged.

In the planar light source device 50, the color of the reflecting region 8b of the reflecting sheet 8 is changed to make it possible to change the color of light emitted from the light guide plate 3. In FIG. 8, the blue, green, and red reflecting regions 8b of the reflecting sheet 8 are exemplified. However, the color of the reflecting region 8b is not limited to these colors. Two color inks such as blue and green inks, green and red inks, or red and blue inks are mixed with each other in the reflecting sheet 8, or the two inks are alternately printed to make it possible to adjust colors to a desired chromaticity point indicated by a triangle in FIG. 8. Not only the chromaticity of the reflecting region 8b, depending on the desired chromaticity point, but also the arrangement and the range of the reflecting region 8b can be arbitrarily adjusted.

As described above, the planar light source device 50 according to the first preferred embodiment includes the upper case 5 and the lower case 1 configuring a housing having the opening 5a, the point light sources 7 arranged on at least one side surface in the housing, the light guide plate 3 arranged in the housing and having the light-emitting surface 3b facing the opening 5a and the counter-emitting surface 3c being opposite to the light-emitting surface 3b, the reflecting sheet 2 arranged on the counter-emitting surface 3c side of the light guide plate 3 in the housing, and the reflecting region 8b arranged on at least a part of a peripheral portion of the point light sources 7 on the side surface on which the point light sources 7 are arranged in the housing and absorbing light having at least some wavelength.

Thus, of light emitted from the point light sources 7, a part of light that is not incident on the light guide plate 3 can be reflected by the reflecting region 8b and incident on the light guide plate 3, so that a brightness on the light-emitting surface 3b can be improved. Of light emitted from the point light sources 7 and being incident on the light guide plate 3, light having some wavelength is absorbed by the reflecting region 8b. However, only the color of light reflected by the reflecting region 8b changes, and the color of light emitted from the light-emitting surface 3b does not largely change, so that fine color adjustment can be performed. In this manner, sufficient display quality can be achieved.

In the housing, the reflecting sheet 8 arranged in a region except for the region in which the point light sources 7 are arranged on the side surface on which the point light sources 7 are arranged is further included, and the reflecting region 8b is formed by performing printing having a reflectance varying depending on wavelengths to the reflecting sheet 8.

Thus, unlike in a normal method in which a colored sheet is arranged on a part of an optical sheet arranged on a light-emitting surface, the colored sheet manufactured by a special manufacturing method is not required. In addition, since the printing is performed on the reflecting sheet 8 arranged on the side surface in the housing, the side surface serving as a portion being different from the light-emitting surface, print quality is not directly visually recognized, and it is advantageous that there is no necessity to strictly manage print level quality.

In the normal method, since the spectrum on the light-emitting surface is directly absorbed by the colored sheet to change the chromaticity, even though the change in color of the colored sheet is small, the color of light emitted from the light-emitting surface largely changes disadvantageously. In the first preferred embodiment, even though the reflecting region 8b of the reflecting sheet 8 is printed in a single color (for example, blue, green, or red), the change in chromaticity has a level shown in FIG. 8, the chromaticity of light emitted from the light-emitting surface does not largely change, and color adjustment can be more accurately performed.

In this case, the reflecting region may be formed by performing printing having a reflectance varying depending on wavelengths to the flat cable 6 on which the point light sources 7 are mounted. In this case, the reflecting sheet 8 is not required, and the number of components can be reduced, so that a planar light source device can be provided at less cost. Since the printing is dot printing, printing can be easily performed to the reflecting sheet 8 or the flat cable 6.

Since the reflecting region 8b has an absorption peak at at least one of 450±20 nm, 550±20 nm, and 630±20 nm, the wavelengths are combined to each other to make it possible to adjust the color to a desired chromaticity point. Since the point light sources 7 are formed by using LEDs, a power consumption in the planar light source device 50 can be reduced. More specifically, an energy consumption in the planar light source device 50 can be reduced.

Since the display device includes the planar light source device 50 and the display unit arranged on the light-emitting surface 3b side in the planar light source device 50, the display device can also achieve the above advantages.

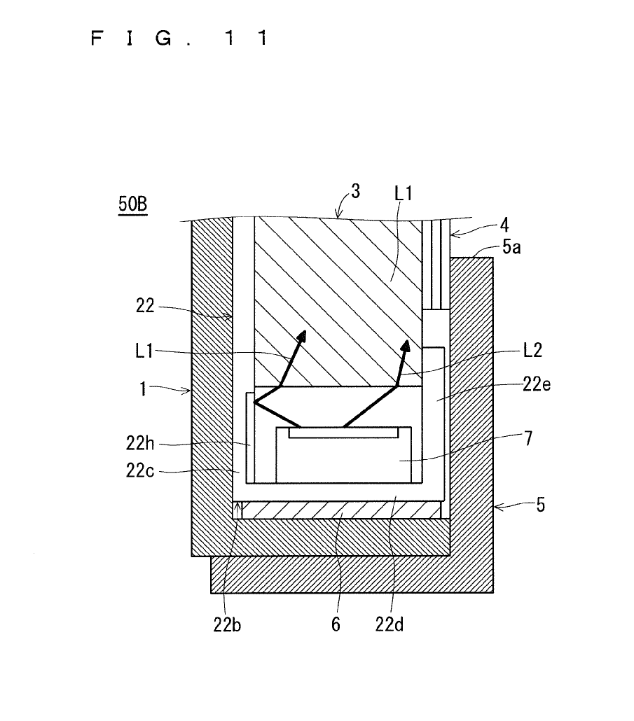

A planar light source device 50A according to a modification of the first preferred embodiment will be described below. FIG. 9 is a perspective view of a reflecting sheet 22 of the planar light source device 50A according to the modification of the first preferred embodiment, and FIG. 10 is a diagram corresponding to FIG. 3 of the modification of the first preferred embodiment.

As shown in FIG. 9 and FIG. 10, in the modification of the first preferred embodiment, a reflecting sheet arranged on the counter-emitting surface 3c side of the light guide plate 3 and a reflecting sheet arranged on the point light sources 7 side are integrated with each other. The reflecting sheet 22 (fifth reflecting sheet) includes a main body 22a serving as a portion being in contact with the counter-emitting surface 3c of the light guide plate 3 and a projecting portion 22b (second projecting portion) projecting from an end portion of the light guide plate 3 to a region except for a region in which the point light sources 7 are arranged on the side surface on which the point light sources 7 are arranged.

The projecting portion 22b is configured by a lower surface portion 22c extending from the main body 22a to the side surface on which the point light sources 7 are arranged, a side surface portion 22d arranged on a front surface of the flat cable 6 on which the point light sources 7 are mounted in the lower case 1, and an upper surface portion 22e being opposite to the lower surface portion 22c and extending to the opening 5a side.

The side surface portion 22d includes holes 22f to expose the point light sources 7 and a reflecting region 22g. Since the reflecting region 22g is formed by using the same method as that for the reflecting region 8b, a detailed description thereof will not be performed.

As described above, the planar light source device 50A according to the modification of the first preferred embodiment includes the upper case 5 and the lower case 1 configuring a housing having the opening 5a, the point light sources 7 arranged on at least one side surface in the housing, the light guide plate 3 arranged in the housing and having the light-emitting surface 3b facing the opening 5a and the counter-emitting surface 3c being opposite to the light-emitting surface 3b, the reflecting sheet 22 arranged on the counter-emitting surface 3c side of the light guide plate 3 in the housing and having the projecting portion 22b projecting from an end of the light guide plate 3 to a region except for the region in which the point light sources 7 are arranged on the side surface on which the point light sources 7 are arranged, and the reflecting region 22g arranged on at least a part of a peripheral portion of the point light sources 7 on the projecting portion 22b and absorbing light having at least some wavelength.

Thus, of light emitted from the point light sources 7, a part of light that is not incident on the light guide plate 3 can be reflected by the reflecting region 22g and incident on the light guide plate 3, so that a brightness on the light-emitting surface 3b can be improved. Of light emitted from the point light sources 7 and being incident on the light guide plate 3, light having some wavelength is absorbed by the reflecting region 22g. However, only the color of light reflected by the reflecting region 22g changes, and the color of light emitted from the light-emitting surface 3b does not largely change, so that fine color adjustment can be achieved. In this manner, sufficient display quality can be achieved. Since the reflecting sheet arranged on the counter-emitting surface 3c side of the light guide plate 3 and the reflecting sheet arranged on the point light sources 7 side are integrated with each other, the number of components can be reduced to make it possible to provide a planar light source device at less cost.

Since the reflecting region 22g is formed by performing printing having a reflectance varying depending on wavelengths to the reflecting sheet 22, a colored sheet manufactured by a special manufacturing method is not required. In addition, since the printing is performed on the side surface portion 22d of the reflecting sheet 22 arranged on the side surface in the housing, the side surface serving as a portion being different from the light-emitting surface, print quality is not directly visually recognized, and it is advantageous that there is no necessity to strictly manage print level quality.

### Second Preferred Embodiment

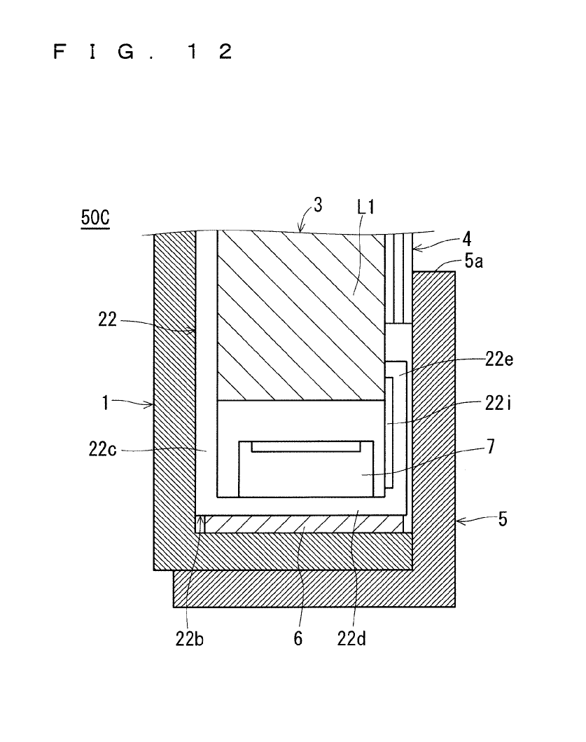

A planar light source device 50B according to a second preferred embodiment will be described below. FIG. 11 is a diagram corresponding to FIG. 3 of the second preferred embodiment. The same reference numerals as in the first preferred embodiment denote the same constituent elements as in the second preferred embodiment, and a detailed description thereof will not be performed.

As shown in FIG. 11, in the second preferred embodiment, as in the modification of the first preferred embodiment, the reflecting sheet 22 is arranged. In place of the side surface portion 22d of the reflecting sheet 22, a reflecting region 22h is formed on the lower surface portion 22c of the reflecting sheet 22. Since the reflecting region 22h is formed by using the same method as in the reflecting region 8b, a detailed description thereof will not be performed.

(Path of Light)

Most of light rays emitted from the point light sources 7 are incident on the side surface (incident surface 3a) of the light guide plate 3. The light being incident on the light guide plate 3 propagates in the light guide plate 3 while being repeatedly reflected between the light-emitting surface 3b and the counter-emitting surface 3c of the light guide plate 3. Light being incident on the dots formed on the counter-emitting surface 3c of the light guide plate 3 are emitted from the light-emitting surface 3b side of the light guide plate 3. Light distribution for the light emitted from the light-emitting surface 3b side is controlled by the optical sheets 4 to polarize the light, and the light is emitted from the opening 5a of the upper case 5.

Some of the light rays emitted from the point light sources 7 are reflected by the reflecting region 22h of the reflecting sheet 22 and incident on the incident surface 3a of the light guide plate 3. In this case, a spectrum of light emitted from the point light sources 7 is reflected by the reflecting region 22h to largely change the spectrum of light. For example, the reflecting region 22h colored in blue mainly reflects light having a wavelength of about 450 nm in the spectrum of the point light sources 7. The reflected light is incident on the incident surface 3a of the light guide plate 3 again. The incident light is mixed in color with light being directly incident on the point light sources 7 to be emitted from the opening 5a of the upper case 5.

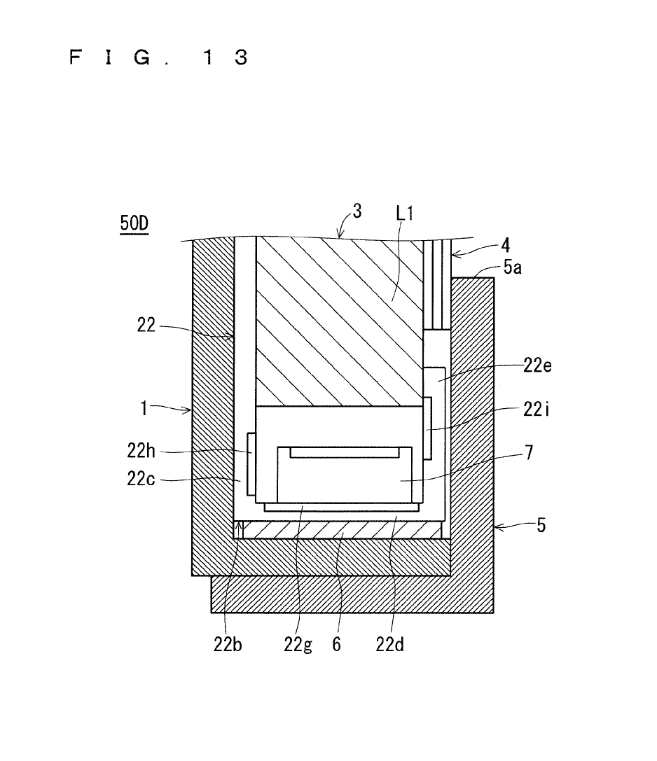

In this case, the reflecting region is not formed on the lower surface portion 22c of the reflecting sheet 22 but may be formed on the upper surface portion 22e of the reflecting sheet 22. FIG. 12 is a diagram corresponding to FIG. 3 of a first modification of the second preferred embodiment. As shown in FIG. 12, in a planar light source device 50C according to the first modification of the second preferred embodiment, the reflecting region 22h is formed on the upper surface portion 22e of the reflecting sheet 22. In the second preferred embodiment and the first modification of the second preferred embodiment, the reflecting sheet 22 corresponds to a third sheet, and the projecting portion 22b corresponds to a first projecting portion.

As described above, each of the planar light source device 50B according to the second preferred embodiment and the planar light source device 50C according to the first modification of the second preferred embodiment includes the upper case 5 and the lower case 1 configuring a housing having the opening 5a, the point light sources 7 arranged on at least one side surface in the housing, the light guide plate 3 arranged in the housing and having the light-emitting surface 3b facing the opening 5a and the counter-emitting surface 3c being opposite to the light-emitting surface 3b, the reflecting sheet 22 arranged on the counter-emitting surface 3c side of the light guide plate 3 in the housing and having the projecting portion 22b projecting from an end of the light guide plate 3 to the light-emitting surface 3b side through the side surface on which the point light sources 7 are arranged, and the reflecting region 22h or a reflecting region 22i arranged on at least a part of the projecting portion 22b on the light-emitting surface 3b side or the counter-emitting surface 3c side and absorbing light having at least some wavelength.

Thus, in the housing since an amount of light reaching the light-emitting surface 3b side and the counter-emitting surface 3c side is larger than an amount of light reaching the side surface on which the point light sources 7 are arranged, the light rays can be reflected to be incident on the light guide plate 3, and a brightness on the light-emitting surface 3b can be more improved.

Since the reflecting region 22h or the reflecting region 22i is formed by performing printing having a reflectance varying depending on wavelengths to the projecting portion 22b of the reflecting sheet 22, a colored sheet manufactured by a special manufacturing method is not required. In addition, since the printing is performed on the projecting portion 22b of the reflecting sheet 22 arranged on the lower surface or the upper surface in the housing, the lower surface or the upper surface serving as a portion being different from the light-emitting surface, print quality is not directly visually recognized, and it is advantageous that there is no necessity to strictly manage print level quality.

The main body and the projecting portion on the reflecting sheet may be formed by different members, and a reflecting region may be formed on the lower surface portion and the upper surface portion of the projecting portion. In this case, the main body corresponds to the first reflecting sheet, and the projecting portion corresponds to the fourth reflecting sheet.

As described above, the planar light source device includes the housing having the opening 5a, the point light sources 7 arranged on at least one side surface in the housing, the light guide plate 3 arranged in the housing and having the light-emitting surface 3b facing the opening 5a and the counter-emitting surface 3c being opposite to the light-emitting surface 3b, the first reflecting sheet arranged on the counter-emitting surface 3c side of the light guide plate 3 in the housing, and the reflecting region arranged on at least a part of a surface on the point light sources 7 side on a surface of the light-emitting surface 3b side or the counter-emitting surface 3c side in the housing and absorbing light having at least some wavelength. The planar light source device further includes a fourth reflecting sheet arranged on the point light sources 7 side on the surface of the light-emitting surface 3b side or the counter-emitting surface 3c side in the housing, and the reflecting region is formed by performing printing having a reflectance varying depending on wavelengths to the fourth reflecting sheet. Thus, also in this case, the same advantages as in the planar light source device 50B according to the second preferred embodiment and the planar light source device 50C according to the first modification of the second preferred embodiment can be obtained.

On the reflecting sheet 22, the reflecting region may be formed on the lower surface portion 22c, the side surface portion 22d, and the upper surface portion 22e. FIG. 13 is a diagram corresponding to FIG. 3 of the second modification of the second preferred embodiment. As shown in FIG. 13, in a planar light source device 50D according to the second modification of the second preferred embodiment, on the reflecting sheet 22, the reflecting region 22h, the reflecting region 22g, and the reflecting region 22i may be formed on the lower surface portion 22c, the side surface portion 22d, and the upper surface portion 22e, respectively.

As described above, in the planar light source device 50D according to the second modification of the second preferred embodiment, since the reflecting region is increased to increase an amount of light reflected by the reflecting regions 22g, 22h, and 22i, the chromaticity of light emitted from the light-emitting surface 3b can be adjusted within an appropriate range.

While the invention has been shown and described in detail, the foregoing description is in all aspects illustrative and not restrictive. It is therefore understood that numerous modifications and variations can be devised without departing from the scope of the invention.

What is claimed is:

1. A planar light source device comprising:
a housing having an opening;
a light source arranged on at least one side surface in said housing;
a light guide plate arranged in said housing and having a light-emitting surface facing said opening and a counter-emitting surface being opposite to said light-emitting surface;
a first reflecting sheet arranged on said counter-emitting surface side of said light guide plate in said housing; and
a reflecting region arranged on at least a part of a peripheral portion of said light source on the side surface on which said light source is arranged and absorbing light having at least some wavelength.

2. The planar light source device according to claim 1, comprising a second reflecting sheet arranged in a region except for a region in which said light source is arranged on the side surface on which said light source is arranged in said housing, wherein
said reflecting region is formed by performing printing having a reflectance varying depending on wavelengths to said second reflecting sheet.

3. The planar light source device according to claim 1, comprising a circuit board for supplying an electric power to said light source, wherein
said light source is arranged on at least one side surface in said housing through said circuit board,
said reflecting region is formed by performing printing having a reflectance varying depending on wavelengths on said circuit board.

4. The planar light source device according to claim 2, wherein said printing is dot printing.

5. A planar light source device comprising:
a housing having an opening;
a light source arranged on at least one side surface in said housing;
a light guide plate arranged in said housing and having a light-emitting surface facing said opening and a counter-emitting surface being opposite to said light-emitting surface;
a third reflecting sheet arranged on said counter-emitting surface side of said light guide plate and having a first projecting portion projecting from an end of said light guide plate to said light-emitting surface side through the side surface on which said light source is arranged in said housing; and
a reflecting region arranged on at least a part of said light-emitting surface side or said counter-emitting surface side on said first projecting portion and absorbing light having at least some wavelength.

6. The planar light source device according to claim 5, wherein said reflecting region is formed by performing printing having a reflectance varying depending on wavelengths to said first projecting portion of said third reflecting sheet.

7. A planar light source device comprising:
a housing having an opening;
a light source arranged on at least one side surface in said housing;
a light guide plate arranged in said housing and having a light-emitting surface facing said opening and a counter-emitting surface being opposite to said light-emitting surface;
a first reflecting sheet arranged on said counter-emitting surface side of said light guide plate in said housing; and
a reflecting region arranged on at least a part of said light-emitting surface side on a surface of said light-emitting surface side or said counter-emitting surface side in said housing and absorbing light having at least some wavelength.

8. The planar light source device according to claim 7, comprising a fourth reflecting sheet arranged on said light source side on the surface of said light-emitting surface side or said counter-emitting surface side in the housing, wherein
said reflecting region is formed by performing printing having a reflectance varying depending on wavelengths to said fourth reflecting sheet.

9. A planar light source device comprising:
a housing having an opening;
a light source arranged on at least one side surface in said housing;
a light guide plate arranged in said housing and having a light-emitting surface facing said opening and a counter-emitting surface being opposite to said light-emitting surface;
a fifth reflecting sheet arranged on said counter-emitting surface side of said light guide plate in said housing and having a second projecting portion projecting from an end of said light guide plate to a region except for a region in which said light source is arranged on the side surface on which said light source is arranged in said housing; and
a reflecting region arranged on at least a part of a peripheral portion of said light source and absorbing light having at least some wavelength.

10. The planar light source device according to claim 9, wherein said reflecting region is formed by performing printing having a reflectance varying depending on wavelengths to said fifth reflecting sheet.

11. The planar light source device according to claim 1, wherein said reflecting region has an absorption peak at at least one of wavelengths 450±20 nm, 550±20 nm, and 630±20 nm

12. The planar light source device according to claim 1, wherein said light source is formed by using a light-emitting diode.

13. A display device comprising:
a planar light source device according to claim 1; and
a display unit arranged on said light-emitting surface side in said planar light source device.

14. A display device comprising:
a planar light source device according to claim 5; and
a display unit arranged on said light-emitting surface side in said planar light source device.

15. A display device comprising:
a planar light source device according to claim 7; and
a display unit arranged on said light-emitting surface side in said planar light source device.

16. A display device comprising:
a planar light source device according to claim 9; and
a display unit arranged on said light-emitting surface side in said planar light source device.
